(19) United States
(12) Patent Application Publication
(10) Pub. No.: US 2014/0372424 A1
(43) Pub. Date: Dec. 18, 2014

(54) METHOD AND SYSTEM FOR SEARCHING VIDEO SCENES

(71) Applicant: THOMSON LICENSING, Issy de Moulineaux (FR)

(72) Inventors: Stelian M. MARKOV, La Crescenta, CA (US); Lee D. Shartzer, Valencia, CA (US); Patrick Sean Gildea, La Canada, CA (US)

(21) Appl. No.: 13/958,876

(22) Filed: Aug. 5, 2013

Related U.S. Application Data
(60) Provisional application No. 61/836,332, filed on Jun. 18, 2013.

(51) Int. Cl. G06F 17/30

(52) U.S. Cl. CPC G06F 17/30852
USPC 707/725; 707/722

(57) ABSTRACT

A method and system are provided for searching video scenes. The method includes receiving user inputs specifying one or more titles of one or more respective video contents and an item relating to one or more scenes in the video contents. The method further includes performing a scene-based search using the one or more titles and the item as search criteria to obtain search results corresponding to individual scenes in the video contents associated with the item. The method also includes providing the search results to a user on a display device.

### CROSS-REFERENCE TO RELATED APPLICATIONS

This application claims the benefit of U.S. Provisional Application Ser. No. 61/836,332 (Attorney Docket No. PU130083), filed Jun. 18, 2013, which is incorporated by reference herein in its entirety.

### TECHNICAL FIELD

The present principles relate generally to video and, more particularly, to a method and system for searching video scenes.

### BACKGROUND

Currently, video searches are supported that return information on a video title basis. However, further granularity in the search results would be beneficial.

### SUMMARY

These and other drawbacks and disadvantages of the prior art are addressed by the present principles, which are directed to a method and system for searching video scenes.

According to an aspect of the present principles, there is provided a method. The method includes receiving user inputs specifying one or more titles of one or more respective video contents and an item relating to one or more scenes in the video contents. The method further includes performing a scene-based search using the one or more titles and the item as search criteria to obtain search results corresponding to individual scenes in the video contents associated with the item. The method also includes providing the search results to a user on a display device.

According to another aspect of the present principles, there is provided a system. The system includes a scene based searcher for receiving user inputs specifying one or more titles of one or more respective video contents and an item relating to one or more scenes in the video contents, and for performing a scene-based search using the one or more titles and the item as search criteria to obtain search results corresponding to individual scenes in the video contents associated with the item. The system further includes a transmission device for transmitting the search results for display to a user on a display device.

According to yet another aspect of the present principles, there is provided a non-transitory computer readable storage medium having computer executable code stored thereon for performing a method. The method includes receiving user inputs specifying one or more titles of one or more respective video contents and an item relating to one or more scenes in the video contents. The method further includes performing a scene-based search using the one or more titles and the item as search criteria to obtain search results corresponding to individual scenes in the video contents associated with the item. The method also includes providing the search results to a user on a display device.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 shows an exemplary system 100 for delivering video content to which the present principles may be applied, in accordance with an embodiment of the present principles;

FIG. 2 shows an exemplary processing system 200 to which the present principles may be applied, according to an embodiment of the present principles, is shown;

FIG. 3 shows an exemplary system 300 for searching video scenes, in accordance with an embodiment of the present principles;

FIG. 4 shows an exemplary method 400 for searching video scenes, in accordance with an embodiment of the present principles;

FIG. 5 shows search results 500 corresponding to a particular actor in a particular movie, in accordance with an embodiment of the present principles;

FIG. 6 shows alternative search results 600 corresponding to a particular actor in a particular movie, in accordance with an embodiment of the present principles;

FIG. 7 shows other alternative search results 700 corresponding to a particular actor in a particular movie, in accordance with an embodiment of the present principles;

FIG. 8 shows an expansion 800 of a portion of the timeline 710 shown in FIG. 7, in accordance with an embodiment of the present principles; and

FIG. 9 shows the results 900 of a scene ordering function, in accordance with an embodiment of the present principles.

### DETAILED DESCRIPTION

The present principles are directed to a method and system for searching video scenes. Advantageously, a user can input search criteria to find matching scenes in a video. As used herein, the terms “video” and “video content” interchangeably refer to a sequence of moving pictures. The moving pictures can depict a movie, a television program, and so forth, as readily appreciated by one of ordinary skill in the art.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “NB”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Initially, a system for delivering various types of content to a user will be described.

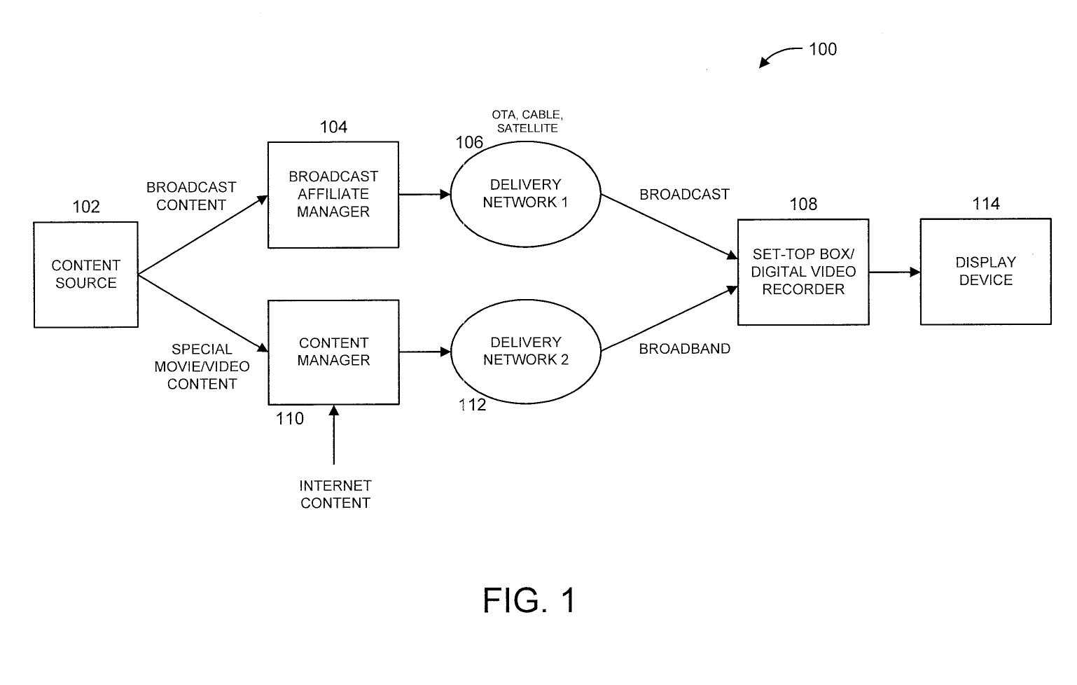

FIG. 1 shows an exemplary system 100 for delivering video content to which the present principles may be applied, in accordance with an embodiment of the present principles. The content originates from a content source 102, such as a movie studio or production house. The content may be supplied in at least one of two forms. One form may be a broadcast form of content. The broadcast content is provided to the broadcast affiliate manager 104, which is typically a national broadcast service, such as the American Broadcasting Company (ABC), National Broadcasting Company (NBC), Columbia Broadcasting System (CBS), etc. The broadcast affiliate manager may collect and store the content, and may schedule delivery of the content over a deliver network, shown as delivery network 1 (106). Delivery network 1 (106) may include satellite link transmission from a national center to one or more regional or local centers. Delivery network 1 (106) may also include local content delivery using local delivery systems such as over the air broadcast, satellite broadcast, or cable broadcast. The locally delivered content is provided to a user's set top box/digital video recorder (DVR) 108 in a user's home, where the content will form part of the results of subsequent searches by the user.

A second form of content is referred to as special content. Special content may include content that may have been delivered as premium viewing, pay-per-view, or other content otherwise not provided to the broadcast affiliate manager. In many cases, the special content may be content requested by the user. The special content may be delivered to a content manager 110. The content manager 110 may be a service provider, such as an Internet website, affiliated, for instance, with a content provider, broadcast service, or delivery network service. The content manager 110 may also incorporate Internet content into the delivery system, or explicitly into the search only such that content may be searched that has not yet been delivered to the user's set top box/digital video recorder 108. The content manager 110 may deliver the content to the user's set top box/digital video recorder 108 over a separate delivery network, delivery network 2 (112). Delivery network 2 (112) may include high-speed broadband Internet type communications systems. It is important to note that the content from the broadcast affiliate manager 104 may also be delivered using all or parts of delivery network 2 (112) and content from the content manager 110 may be delivered using all or parts of Delivery network 1 (106). In addition, the user may also obtain content directly from the Internet via delivery network 2 (112) without necessarily having the content managed by the content manager 110.

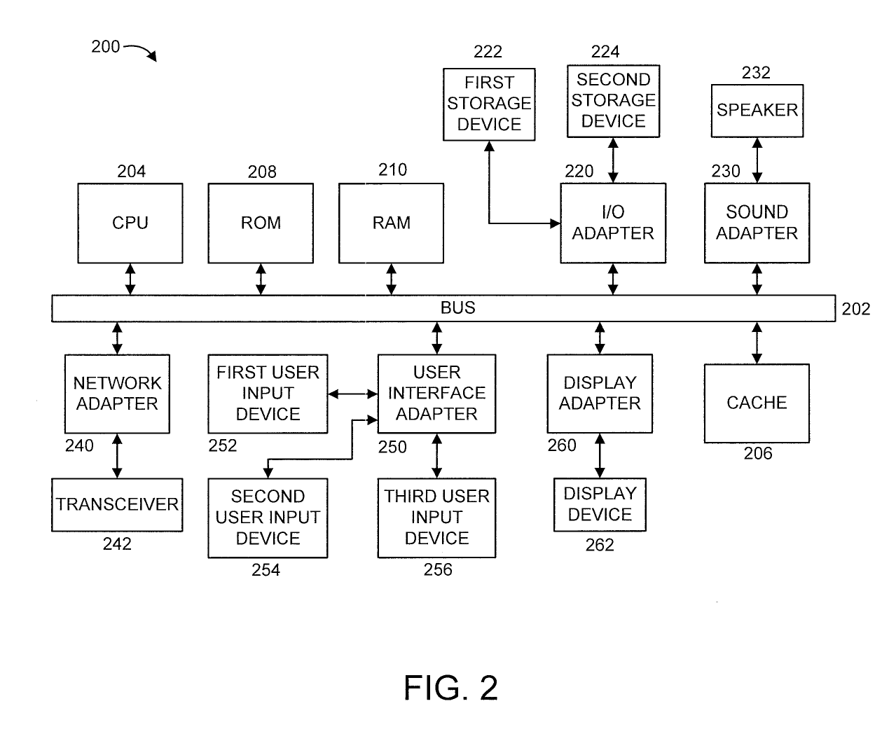

The set top box/digital video recorder 108 may receive different types of content from one or both of delivery network 1 and delivery network 2. The set top box/digital video recorder 108 processes the content, and provides a separation of the content based on user preferences and commands. The set top box/digital video recorder may also include a storage device, such as a hard drive or optical disk drive, for recording and playing back audio and video content. The processed content is provided to a display device 114. The display device 114 may be a conventional 2-D type display or may alternatively be an advanced 3-D display. It should be appreciated that other devices having display capabilities such as wireless phones, PDAs, computers, gaming platforms, remote controls, multi-media players, or the like, may employ the teachings of the present disclosure and are considered within the scope of the present disclosure. In some embodiments, at least display device 114, and in other embodiments, also set top box/digital video recorder 108, can be replaced by a processing system having a display such as processing system 200 shown and described with respect to FIG. 2. The processing system 200 can be representative of any media consumption/presentation device.

FIG. 2 shows an exemplary processing system 200 to which the present principles may be applied, according to an embodiment of the present principles, is shown. The processing system 200 includes at least one processor (CPU) 204 operatively coupled to other components via a system bus 202. A cache 206, a Read Only Memory (ROM) 208, a Random Access Memory (RAM) 210, an input/output (I/O) adapter 220, a sound adapter 230, a network adapter 240, a user interface adapter 250, and a display adapter 260, are operatively coupled to the system bus 202.

A first storage device 222 and a second storage device 224 are operatively coupled to system bus 202 by the I/O adapter 220. The storage devices 222 and 224 can be any of a disk storage device (e.g., a magnetic or optical disk storage device), a solid state magnetic device, and so forth. The storage devices 222 and 224 can be the same type of storage device or different types of storage devices.

A speaker 232 is operative coupled to system bus 202 by the sound adapter 230.

A transceiver 242 is operatively coupled to system bus 202 by network adapter 240.

A first user input device 252, a second user input device 254, and a third user input device 256 are operatively coupled to system bus 202 by user interface adapter 250. The user input devices 252, 254, and 256 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 252, 254, and 256 can be the same type of user input device or different types of user input devices. The user input devices 252, 254, and 256 are used to input and output information to and from system 200.

A display device 262 is operatively coupled to system bus 202 by display adapter 260.

Of course, the processing system 200 may also include other elements (not shown), as readily contemplated by one of skill in the art, as well as omit certain elements. For example, various other input devices and/or output devices can be included in processing system 200, depending upon the particular implementation of the same, as readily understood by one of ordinary skill in the art. For example, various types of wireless and/or wired input and/or output devices can be used.

Moreover, additional processors, controllers, memories, and so forth, in various configurations can also be utilized as readily appreciated by one of ordinary skill in the art. These and other variations of the processing system 200 are readily contemplated by one of ordinary skill in the art given the teachings of the present principles provided herein.

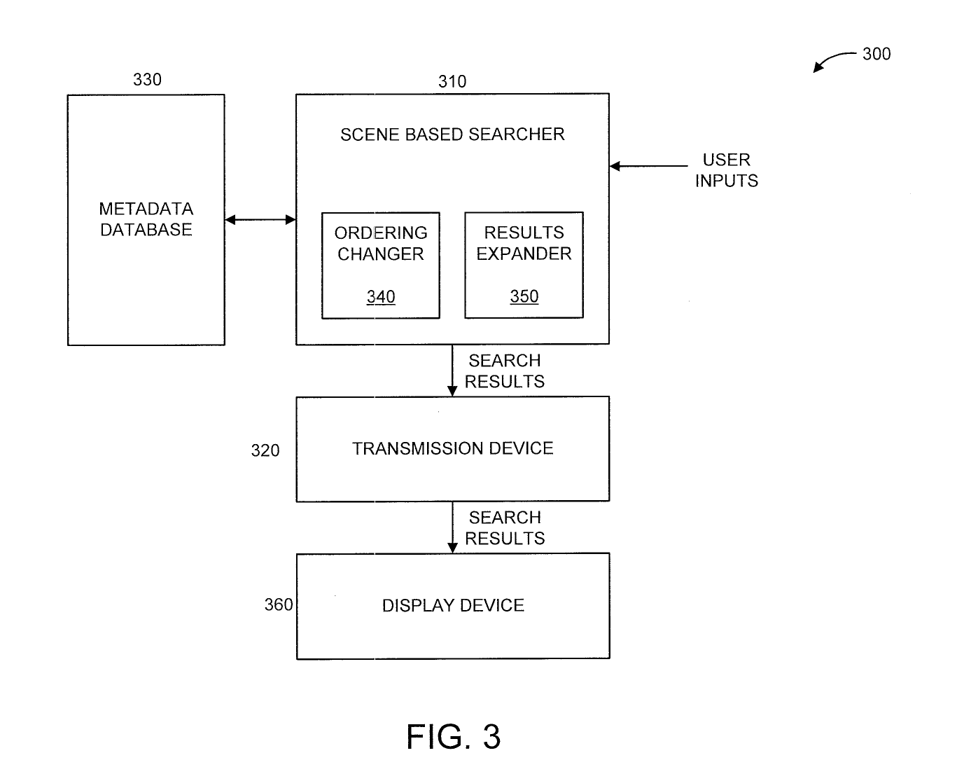

Moreover, it is to be appreciated that system 300 described below with respect to FIG. 3 is a system for implementing respective embodiments of the present principles. Part or all of processing system 200 may be implemented in one or more of the elements of system 300.

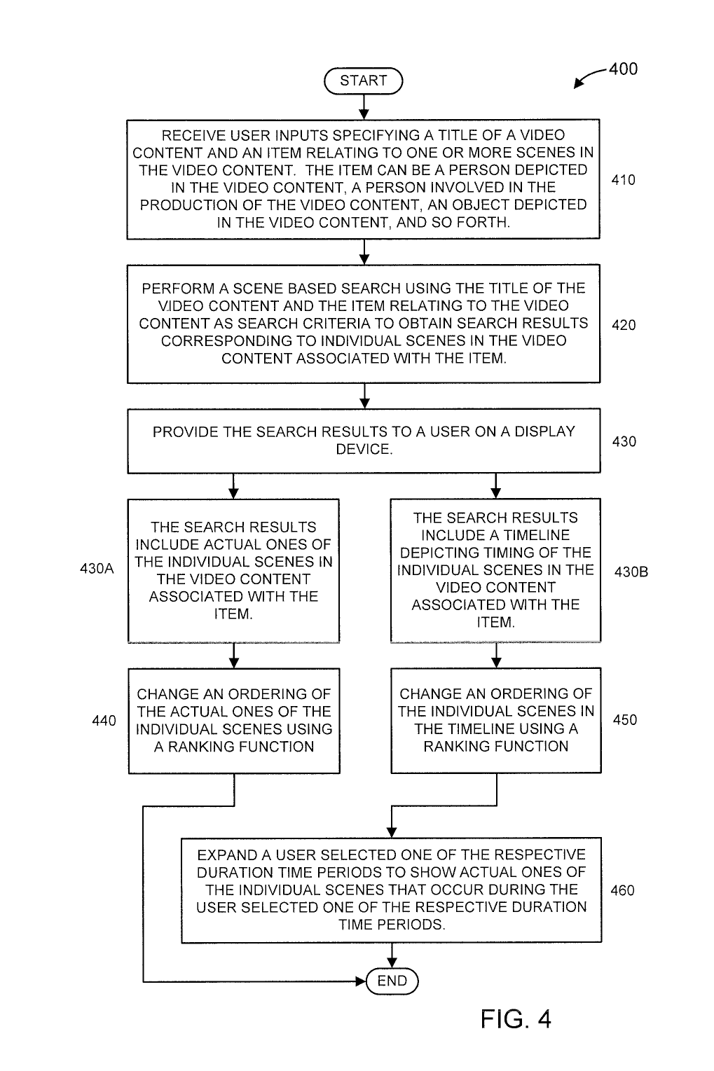

Further, it is to be appreciated that processing system 200 may perform at least part of the method described herein including, for example, at least part of method 400 of FIG. 4. Similarly, part or all of system 300 may be used to perform at least part of method 400 of FIG. 4.

FIG. 3 shows an exemplary system 300 for searching video scenes, in accordance with an embodiment of the present principles. The system 300 includes a scene based searcher 310, a transmission device 320, a metadata database 330, an ordering changer 340, a results expander 350, and a display screen 360.

The scene based searcher 310 receives user inputs specifying a title of a video content and an item relating to one or more scenes in the video content. The scene based searcher 310 performs a scene-based search using the title of the video content and the item relating to the video content as search criteria to obtain search results corresponding to individual scenes in the video content associated with the item. In an embodiment, the item can be any of a person depicted in the video content, a person involved in a production of the video content, an object depicted in the video content, and so forth. While the user inputs are shown directed provided to the scene based searcher, one of ordinary skill in the art will readily appreciate that the user inputs can be provided to the searcher 310 via the transmission device 320 or another transmission device. For example, in an embodiment, the user inputs are provided via a remote control or user interface. The remote control or user interface can correspond to a media consumption device (e.g., a television) that includes the display screen 360, a set top box, and so forth. These and other ways to provide the user inputs to the searcher 310 are readily contemplated by one of ordinary skill in the art, given the teachings of the present principles provided herein.

The metadata database 330 includes metadata for various different video contents including, but not limited to movies, television programs, and so forth. The search performed by the scene based searcher 310 can involve the metadata database 330 or some other database or source of metadata.

The transmission device 320 transmits the search results for display to a user on the display screen 360. It is to be appreciated that one or more of the elements of system 300 can be embodied in a single device and, hence, the implementation of the transmission device 320 will depend upon the configuration of the elements of system 300. Thus, depending upon the configuration of system 300, transmission device 320 can be and/or otherwise include a transceiver, a transmitter, a modem, a wire, and/or so forth as readily contemplated by one of ordinary skill in the art, given the teachings of the present principles provided herein. In any event, the transmission device 320 will include at least some necessary hardware to facilitate transmission of the search results.

The ordering changer 340 changes an ordering of the individual scenes in the timeline using a ranking function responsive to one or more ranking inputs provided by a user. In an embodiment, the ordering is changed to a non-chronological ordering.

The results expander 350 expands a user selected one of the respective duration time periods to show actual ones of the individual scenes that occur during the user selected one of the respective duration time periods, when the timing of the individual scenes depicted in the timeline includes respective duration time periods of the individual scenes.

The display screen 360 displays the search results to the user. The display screen is part of a display device or other device having video content display capabilities.

While the display screen 360 is shown as part of the system 300 in FIG. 3, in other embodiments the system 300 may simply interact with the display screen 360, which can be part of a different system or device (such as a content consumption or content presentation device). These and other variations of the elements of FIG. 3 are readily determined by one of ordinary skill in the art, given the teachings of the present principles provided herein, while maintaining the spirit of the present principles.

FIG. 4 shows an exemplary method 400 for searching video scenes, in accordance with an embodiment of the present principles.

At step 410, receive user inputs specifying a title of a video content and an item relating to one or more scenes in the video content. In an embodiment, the item is at least one of a person (e.g., an actor, an extra, and so forth) depicted in the video content, a person (e.g., a director, a grip, and so forth) involved in a production of the video content, an object (e.g., a building, a landmark, an article of clothing, and so forth) depicted in the video content, and so forth. Of course, the present principles are not limited to the preceding items and, thus, other items relating to one or more scenes of the video content can be specified at step 410. That is, given the teachings of the present principles provided herein, one of ordinary skill in the art will contemplate these and various other items relating to one or more scenes in the video content to which the present principles can be applied, while maintaining the spirit of the present principles.

At step 420, perform a scene based search using the title of the video content and the item relating to the video content as search criteria to obtain search results corresponding to individual scenes in the video content associated with the item.

At step 430, provide the search results to a user on a display device. In an embodiment, the search results provided to the user include actual ones of the individual scenes in the video content associated with the item (430A). In an embodiment, the search results provided to the user include a timeline depicting a timing (e.g., duration (e.g., 6 minutes long), time of occurrence (e.g., at X hour(s) and Y minutes) in the video content, and so forth) of the individual scenes in the video content associated with the item (430B).

Step 440 that follows relates to an embodiment of step 430A, where the search results provided to the user include the actual ones of the individual scenes in the video content associated with the item.

At step 440, change an ordering of the actual ones of the individual scenes using a ranking function responsive to one or more ranking inputs provided by a user. In an embodiment, the ordering is changed to a non-chronological ordering.

Steps 450 and 460 that follow relate to an embodiment of step 430B, where the search results provided to the user include a timeline and the timing of the individual scenes depicted in the timeline include respective duration time periods of the individual scenes.

At step 450, change an ordering of the individual scenes in the timeline using a ranking function responsive to one or more ranking inputs provided by a user. In an embodiment, the ordering is changed to a non-chronological ordering.

At step 460, expand a user selected one of the respective duration time periods to show actual ones of the individual scenes that occur during the user selected one of the respective duration time periods.

It is to be appreciated that while one or more embodiments are described herein with respect to a single title of a single video content for the sake of clarity of illustration, the present principles can be applied to the case of multiple video content titles. That is, while a user is described herein providing a user input specifying a single title of a single video content that is used as (part of) the basis of a search, in other embodiments, the user can input more than one title corresponding to more than one video content, and the search and search results will involve all the titles specified by the user. These and other variations of the present principles are readily determined by one of ordinary skill in the art given the teachings of the present principles provided herein, while maintaining the spirit of the present principles.

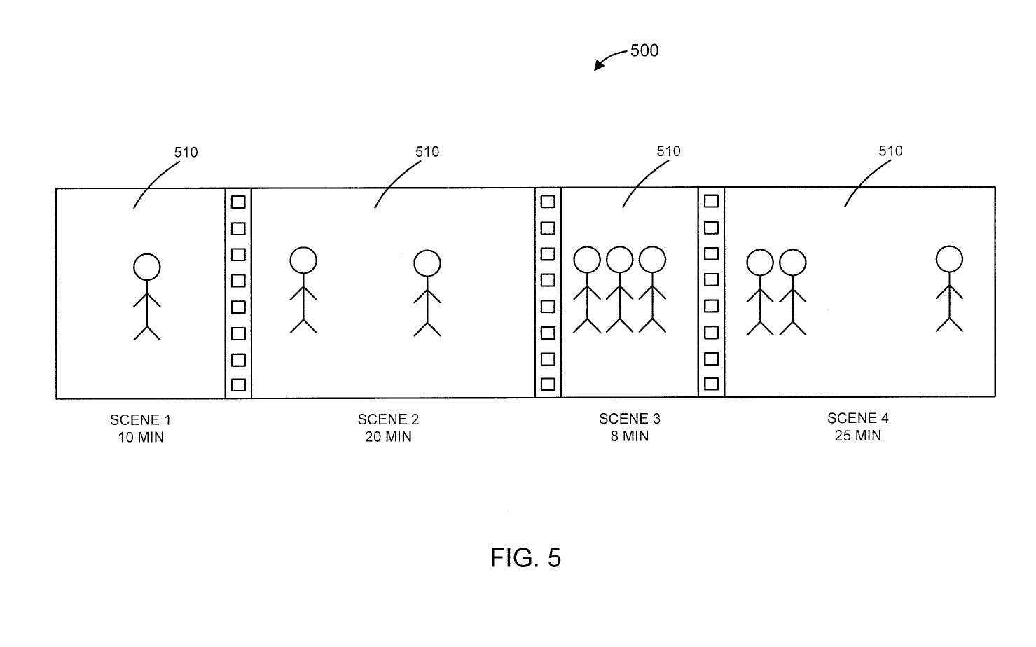

The present principles will now be described with respect to exemplary search results provided in accordance thereby, as shown in FIGS. 5-7. The search results are provided in different forms, but all of the search results shown in FIGS. 5-7 correspond to the same search criteria, namely the name of a particular actor and the name of a particular movie that includes the particular actor.

In an embodiment, the present principles provide a user interface to assist a user in finding different scenes in a video. For example, as described with respect to FIGS. 5-7, a user can type in an actor's name and a movie title. Instead of having a textual list provided to a user, a list of scenes from that movie is returned with that actor. Of course, the preceding search criteria of an actor's name and a movie title are merely exemplary and, thus, other search criteria can also be used, while maintaining the spirit of the present principles.

FIG. 5 shows search results 500 corresponding to a particular actor in a particular movie, in accordance with an embodiment of the present principles. The search results 500 correspond to a search performed in accordance with the present principles, where the actor's name and a movie title are used as search criteria. The search results 500 include multiple scenes 510 corresponding to the particular actor in the particular movie.

One scenario for returning such scenes can come from a pre-existing database that classifies both scenes and the actors that are present in such scenes. It may be the case that a metadata source (e.g., including, but not limited to, DIGITALSMITHS™) already has such metadata present in their database. The scenes and actor information could therefore be returned from the metadata source database, but video captions of the scenes could be generated locally by matching a time code against a locally stored media asset and pulling the relevant video captions from the media asset in a manner consistent with FIG. 5. Alternatively, video captions could be stored on a remote server with the metadata.

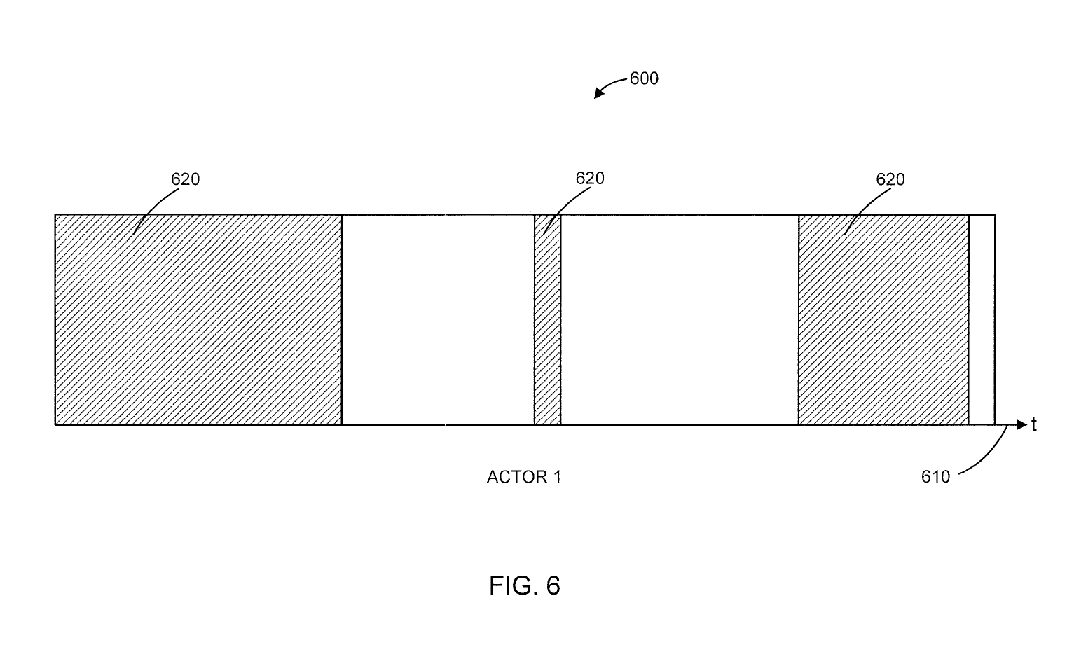

FIG. 6 shows alternative search results 600 corresponding to a particular actor in a particular movie, in accordance with an embodiment of the present principles. The alternate search results 600 are directed to presenting information about where an actor's scenes are in a movie. When a user inputs an actor and a movie, a timeline 610 is shown which displays when an actor is in the movie. The time periods when the actor is in the movie are depicted by the shaded regions 620.

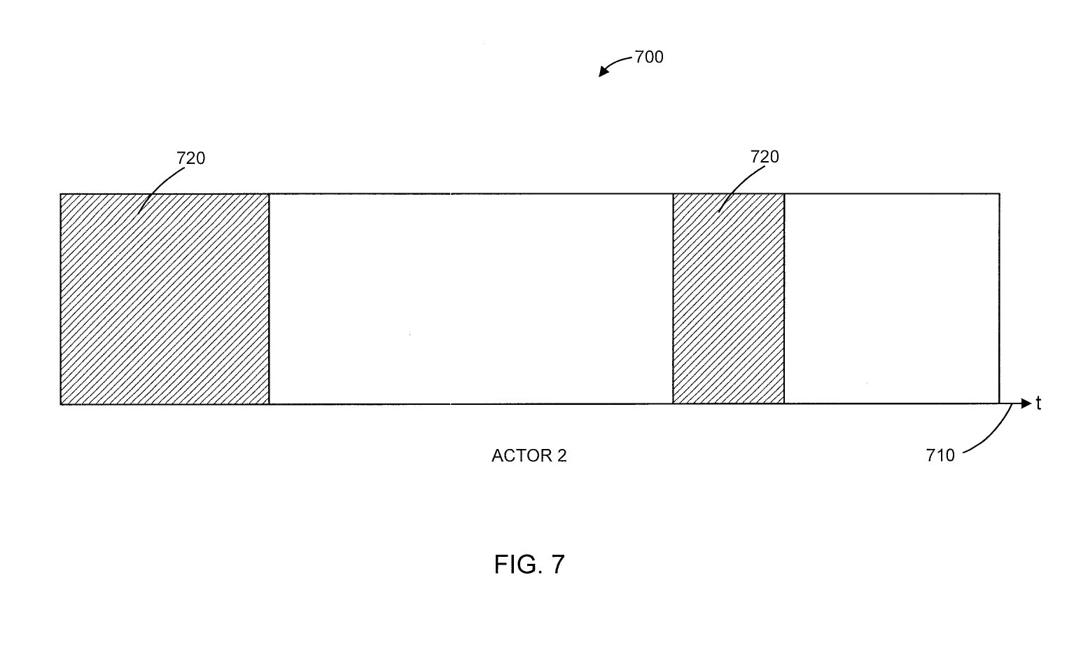

FIG. 7 shows other alternative search results 700 corresponding to a particular actor in a particular movie, in accordance with an embodiment of the present principles. The alternate search results 700 are for a different timeline 710 for the same movie but for a different actor than that corresponding to the search results of FIG. 6. Again, the shaded regions 720 indicate the approximate areas on the timeline where an actor appears during the movie.

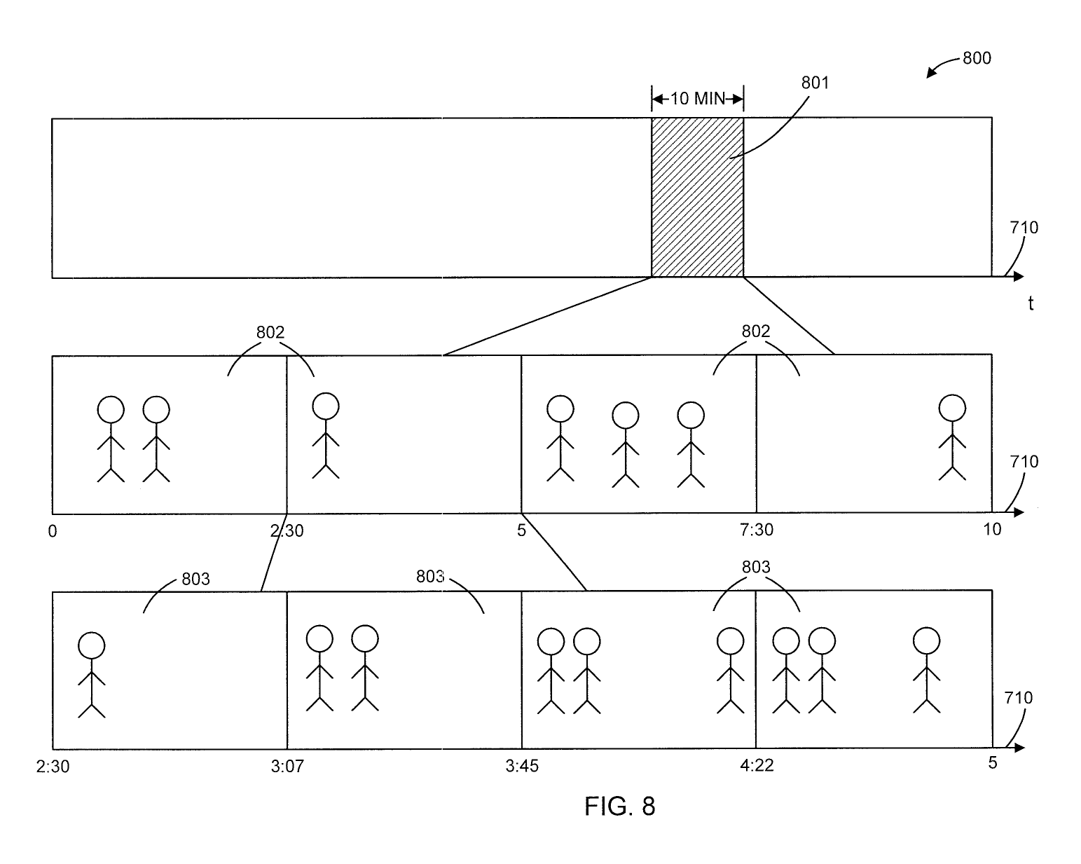

FIG. 8 shows an expansion 800 of a portion of the timeline 710 shown in FIG. 7, in accordance with an embodiment of the present principles. In particular, the expansion 800 relates to a particular actor.

A user using a touch interface or other input device or input means (hereinafter simply “input device” in short) can expand the shaded area shown as being ten minutes long into a listing of scenes 802 which are shown in the middle of the FIG. 8. Four scenes 802 are shown which are denoted as time “0”, “2:30”, “5”, and “7:30” minutes. That is, the ten minute scene 801 shown at the top of FIG. 8 can be divided into the four scenes 802 shown in the middle of FIG. 8. A scene “2:30” which is two and half minutes long can be further divided using the input device into another four scenes 803 (at the bottom of FIG. 8) which are denoted as “2:30”, “3:07”, “3:45”, and “4:22”, where each of these scenes comports to 37.5 seconds. Of course, other time divisions can be employed, while maintaining the spirit of the present principles.

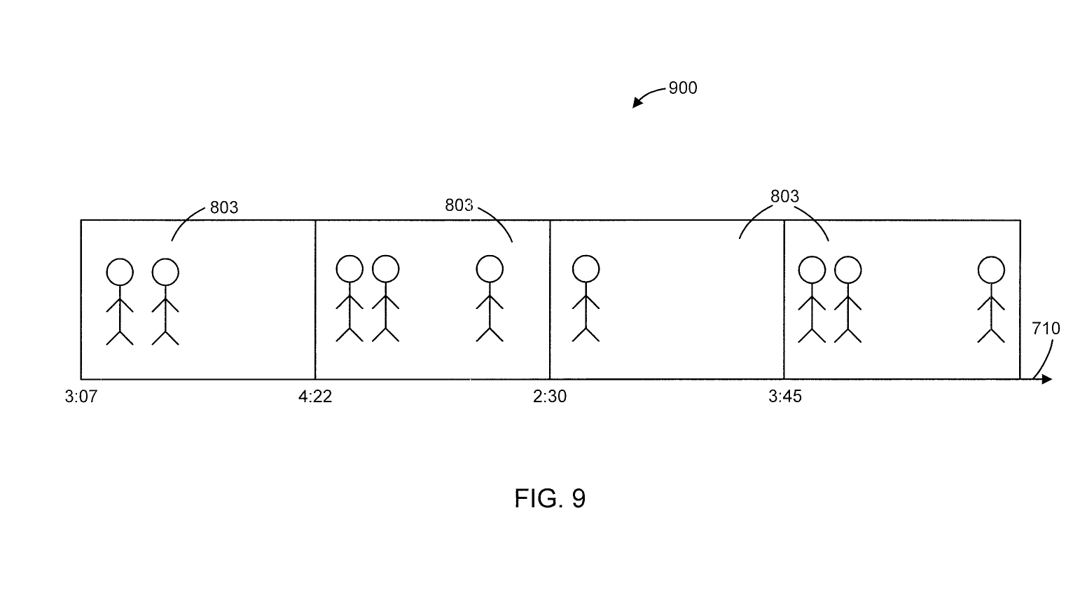

FIG. 9 shows the results 900 of a scene ordering function, in accordance with an embodiment of the present principles. The scene ordering function ranks the scenes 803 that were identified in FIG. 8 based on a particular input and/or an attribute of a selected group of scenes. For example, all of the scenes shown in FIG. 9 are of the same actor in the same time segment, but the chronological order of the scenes is different. The scenes can be ranked based upon the amount of dialogue a specified character utters within a given time period where the scene identified as being “3:07” has the most dialogue for an actor from the time segment “3:07-3:45”. In contrast, the scene ranked fourth representing “3:45” represents the amount of dialogue for a selected actor/character from “3:45-4:22”. Alternatively, the scenes can be ranked based on social media criteria such as, for example, a scene's popularity according to, e.g., people's likes on social networking service (e.g., FACEBOOK™ and so forth) or an online entertainment database (e.g., IMDB™ and so forth). Other ranking criteria can be used, and/or alternatively other ways of presenting the scenes can be done where they are represented with different colors, and the like. These and other variations of presenting the search results and ranking the search results are readily determined by one of ordinary skill in the art, given the teachings of the present principles provided herein, while maintaining the spirit of the present principles.

A description will now be given of some of the many attendant advantages/features of the present invention, some of which have been mentioned above. For example, one advantage/feature is a method that includes receiving user inputs specifying one or more titles of one or more respective video contents and an item relating to one or more scenes in the video contents. The method further includes performing a scene-based search using the one or more titles and the item as search criteria to obtain search results corresponding to individual scenes in the video contents associated with the item. The method also includes providing the search results to a user on a display device.

Another advantage/feature is the method as described above, wherein the item is at least one of a person depicted in the video contents, a person involved in a production of the video contents, and an object depicted in the video contents.

Yet another advantage/feature is the method as described above, wherein the search results provided to the user include actual ones of the individual scenes in the video contents associated with the item.

Still another advantage/feature is the method as described above, wherein the search results provided to the user include a timeline depicting a timing of the individual scenes in the video contents associated with the item.

Moreover, another advantage/feature is the method wherein the search results provided to the user include a timeline depicting a timing of the individual scenes in the video contents associated with the item as described above, and wherein the method further includes changing an ordering of the individual scenes in the timeline using a ranking function responsive to one or more ranking inputs provided by a user.

Further, another advantage/feature is the method wherein the method further includes changing an ordering of the individual scenes in the timeline using a ranking function responsive to one or more ranking inputs provided by a user as described above, and wherein the ordering is changed to a non-chronological ordering.

Also, another advantage/feature is the method wherein the search results provided to the user include a timeline depicting a timing of the individual scenes in the video contents associated with the item as described above, and wherein the timing of the individual scenes depicted in the timeline includes respective duration time periods of the individual scenes, and the method further includes expanding a user selected one of the respective duration time periods to show actual ones of the individual scenes that occur during the user selected one of the respective duration time periods.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. A method, comprising:
receiving user inputs specifying one or more titles of one or more respective video contents and an item relating to one or more scenes in the video contents;
performing a scene-based search using the one or more titles and the item as search criteria to obtain search results corresponding to individual scenes in the video contents associated with the item; and
providing the search results to a user on a display device.

2. The method of claim 1, wherein the item is at least one of a person depicted in the video contents, a person involved in a production of the video contents, and an object depicted in the video contents.

3. The method of claim 1, wherein the search results provided to the user comprise actual ones of the individual scenes in the video contents associated with the item.

4. The method of claim 1, wherein the search results provided to the user comprise a timeline depicting a timing of the individual scenes in the video contents associated with the item.

5. The method of claim 4, further comprising changing an ordering of the individual scenes in the timeline using a ranking function responsive to one or more ranking inputs provided by a user.

6. The method of claim 5, wherein the ordering is changed to a non-chronological ordering.

7. The method of claim 4, wherein the timing of the individual scenes depicted in the timeline comprises respective duration time periods of the individual scenes, and the method further comprises expanding a user selected one of the respective duration time periods to show actual ones of the individual scenes that occur during the user selected one of the respective duration time periods.

8. A system, comprising:
a scene based searcher for receiving user inputs specifying one or more titles of one or more respective video contents and an item relating to one or more scenes in the video contents, and for performing a scene-based search using the one or more titles and the item as search criteria to obtain search results corresponding to individual scenes in the video contents associated with the item; and
a transmission device for transmitting the search results for display to a user on a display device.

9. The system of claim 8, wherein the item is at least one of a person depicted in the video contents, a person involved in a production of the video contents, and an object depicted in the video contents.

10. The system of claim 8, wherein the search results provided to the user comprise actual ones of the individual scenes in the video contents associated with the item.

11. The system of claim 8, wherein the search results provided to the user comprise a timeline depicting a timing of the individual scenes in the video contents associated with the item.

12. The system of claim 11, further comprising an ordering changer for changing an ordering of the individual scenes in the timeline using a ranking function responsive to one or more ranking inputs provided by a user.

13. The system of claim 12, wherein the ordering is changed to a non-chronological ordering.

14. The system of claim 11, wherein the timing of the individual scenes depicted in the timeline comprises respective duration time periods of the individual scenes, and the system further comprises a results expander for expanding a user selected one of the respective duration time periods to show actual ones of the individual scenes that occur during the user selected one of the respective duration time periods.

15. A non-transitory computer readable storage medium having computer executable code stored thereon for performing a method, the method comprising:
receiving user inputs specifying one or more titles of one or more respective video contents and an item relating to one or more scenes in the video contents;
performing a scene-based search using the one or more titles and the item as search criteria to obtain search results corresponding to individual scenes in the video contents associated with the item; and
providing the search results to a user on a display device.
